(19) United States
(12) Patent Application Publication
(10) Pub. No.: US 2017/0246838 A1
(43) Pub. Date: Aug. 31, 2017

(54) GYPSUM PANELS AND METHODS

(71) Applicant: United States Gypsum Company, Chicago, IL (US)

(72) Inventor: Evan Vincent Rohlf, Tower Lakes, IL (US)

(21) Appl. No.: 15/054,487

(22) Filed: Feb. 26, 2016

(51) Int. Cl. B32B 7/12; C01F 11/46; B32B 37/14; E04C 2/24; B32B 37/12; B32B 27/06

(52) U.S. Cl. CPC B32B 7/12; B32B 37/12; B32B 27/06; B32B 37/142; E04C 2/24; C01F 11/46; B32B 2607/00; B32B 2255/12; B32B 2255/26; B32B 2307/726

(57) ABSTRACT

Provided are wallboards in which gypsum core is adhered to a paper cover sheet with an adhesive. Wallboards with laminated paper cover sheets in which an inner water-absorbent cover sheet is adhered to the outer paper cover sheet are provided as well. Methods for making these wallboards are provided as well.

### FIELD OF THE INVENTION

This invention relates to gypsum panels in which a paper cover sheet is bonded to the gypsum core with an adhesive. Methods for making the gypsum panels in which an adhesive is applied to the bond side of a paper cover sheet are provided as well.

### BACKGROUND

Gypsum boards, also known as gypsum panels, drywall or wallboards, are popular construction materials with desirable properties for indoor applications. A gypsum panel is manufactured by forming a gypsum core from a gypsum slurry of calcium sulfate hemihydrate, water and additives, including those disclosed in US Patent Publication 2006/0278127, the entire disclosure of which is incorporated herein by reference.

In commercial practice, a wallboard is produced by continuously depositing a gypsum slurry on a conveyor and sandwiching the gypsum slurry between two paper cover sheets. One paper cover sheet is called the face paper sheet, or facer, and the other paper cover sheet is called the back paper sheet, or backer. Various paper grades can be used in gypsum panels, including Manila grade paper with a smooth calendered finish is often used as the facer paper cover sheet, and Newslined with a rougher finish is often used as the backer paper cover sheet. Both paper grades are multi-ply with at least one liner ply and several filler plies. The Manila liner plies typically use recycled paper from hardwood pulp with shorter fibers as compared to the filler plies in which longer fibers are used. The shorter fiber length from the hardwood pulp provides a smoother surface for painting and decorating. Newslined paper typically has the same fiber type in its liner ply as that used in its filler plies.

Each of the two paper cover sheets has two sides or surfaces. One side of each paper cover sheet is the back or bond side which is the side in contact with a gypsum slurry and is known as the “bottom or back paper side.” The other side of each paper cover sheet is not in contact with the gypsum slurry and is known as the “top or face side.” During wallboard manufacturing, the facer paper cover sheet is rolled out with its bond side facing up. A gypsum slurry is then deposited onto and distributed over the bond side of the facer paper cover sheet. The backer paper cover sheet is then rolled over the gypsum slurry such that the bond side of the backer cover sheet is in contact with the gypsum slurry. The resultant assembly is formed into a wallboard panel. Calcium sulfate hemihydrate in the gypsum slurry reacts with water and is converted into a matrix of interlocking calcium sulfate dihydrate crystals, causing the gypsum slurry to set and form a firm gypsum core of the wallboard panel. This interaction between gypsum crystals and paper is one of bonding forces between a gypsum core and a paper cover sheet in conventional wallboard.

If a wallboard panel is exposed to moisture, the bonding between the gypsum core and paper cover sheet may be weaken, and the paper cover sheet may separate from the gypsum core at least in some areas, causing visible defects in a wall panel and making the wall panel susceptible to microbial growth. Thus, there is a need to strengthen the bonding between a paper cover sheet and a gypsum core, especially under the conditions, where a wallboard is exposed to moisture. Further, multi-ply paper which is heavy by weight is typically used in gypsum panels in order to meet the minimum strength and water resistance requirements, but it is desirable to decrease the weight of paper if this could be achieved without decreasing the strength of a gypsum product or its resistance to water.

### SUMMARY

This invention provides a wallboard panel comprising a gypsum core sandwiched between two paper cover sheets, a facer paper cover sheet and a backer cover sheet, each paper cover sheet in contact with and covering the gypsum core. In this wallboard, each paper cover sheet has a surface proximate to the gypsum core, the bond side of the paper cover sheet, and the bond side of at least one paper cover sheet is coated with an adhesive selected from the group consisting of polyacrylate, polyvinyl acetate (PVA), polyvinyl acetate and borax, polyurethane, and any combination thereof. The inventive board can be prepared with paper which weighs less, but this board still meets the requirements for strength and is water-resistant. At least in some of the embodiments, the facer paper cover sheet, the backer cover sheet or both comprise multi-ply paper which is water absorbent with the water absorption value in the range from 30 g/M² to 200 g/M² as measured by the Cobb test (TAPPI T 441). In some embodiments, the adhesive is a polyacrylate selected from the group consisting of styrene acrylate, vinyl acrylate, styrene acetate acrylate, and any combination thereof. In some embodiments, the adhesive comprises polyvinyl acetate and borax.

Further embodiments include a wallboard panel comprising a gypsum core and at least one laminated paper cover sheet in contact with and covering the gypsum core. In this wallboard panel, the laminated paper cover sheet comprises an inner paper sheet, an adhesive layer, and outer paper sheet, the inner paper sheet being in contact with the gypsum core on one surface and the inner paper sheet being in contact with the adhesive layer on the other surface, and the outer paper sheet is applied over the adhesive layer, and the second adhesive layer is sandwiched between the inner paper sheet and outer paper sheet, and the adhesive layer binds the inner paper sheet and outer paper sheet together. The adhesive layer may comprise a binder selected from the group consisting of polyacrylate, polyvinyl acetate, polyvinyl acetate and borax, polyurethane, and any combination thereof. In some embodiments, a second adhesive layer may be positioned between the gypsum core and the inner paper sheet. At least in some embodiments, the second adhesive layer may comprise a compound selected from the group consisting of polyacrylate, polyvinyl acetate, polyvinyl acetate and borax, polyurethane, and any combination thereof. In some embodiments, the gypsum core is covered with the laminated paper cover sheet on both sides. In some of these wallboards, the inner paper sheet is water absorbent with the water absorption value in the range from 30 g/M² to 200 g/M² as measured by the Cobb test (TAPPI T 441).

Further embodiments are directed to a method of making a wallboard panel, in which a coating is applied to the bond side of a first paper cover sheet, wherein the coating comprises a compound selected from the group consisting of an acrylic resin, PVA resin, PVA resin and borax, polyurethane resin and any mixture thereof. A gypsum slurry is then deposited over the coated bond side of the paper cover sheet while the coating has not fully cured. The gypsum slurry is then covered with a second paper cover sheet; and the gypsum slurry is allowed to set and the coating is allowed to cure. In some embodiments of the method, borax is applied to the bond side of at least one of the first paper cover and the second paper cover sheet prior to the application of the coating. In some embodiments of the method, borax is applied to the bond side of at least one of the first paper cover and the second paper cover sheet after the application of the coating or borax is mixed with the gypsum slurry.

Further embodiments are directed to methods of making a laminated wallboard, in which a laminated paper cover sheet is prepared by adhering together an outer paper sheet and inner paper sheet with an adhesive comprising polyacrylate, polyvinyl acetate (PVA), polyvinyl acetate and borax, polyurethane, and any combination thereof and then covering a gypsum slurry with the laminated paper cover sheet on at least one side such that the inner paper sheet is in contact with the gypsum slurry.

### BRIEF DESCRIPTION OF THE DRAWINGS

FIG. 1 depicts a wallboard panel with an adhesive layer on the bond side of a paper cover sheet.

FIG. 2 depicts a wallboard panel with a laminated paper cover sheet.

### DETAILED DESCRIPTION

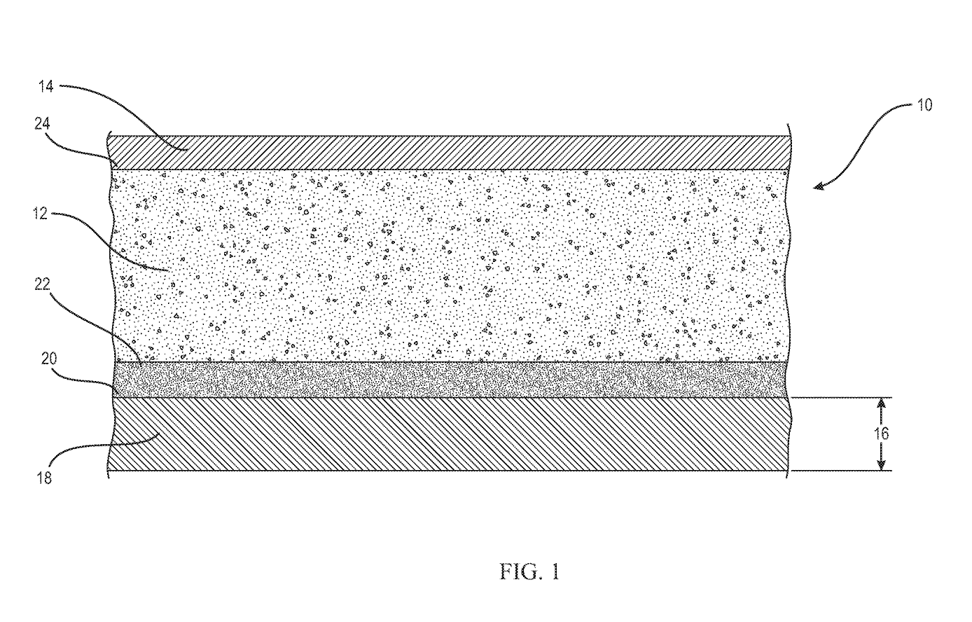

This invention provides a wallboard panel comprising a gypsum core sandwiched between two paper cover sheets, each paper cover sheet in contact with and covering the gypsum core, with the surface of each paper cover sheet proximate to the gypsum core and covering the gypsum core referred to as “the bond side,” and in which the bond side of at least one paper cover sheet is coated with an adhesive selected from polyacrylate, polyvinyl acetate, polyvinyl acetate in combination with borax, polyurethane, or any combination thereof. A person of skill will understand that that term “borax” is used in its common meaning and refers to a sodium salt of boric acid, including sodium borate, sodium tetraborate and/or disodium tetraborate. FIG. 1 depicts one embodiment of the wallboard panel, generally 10, in which a gypsum core 12 is sandwiched between a backer paper cover sheet 14 and a facer paper cover sheet 16 which is multi-ply paper comprising the ply 18. The inner surface of the ply 18 creates the bond side 20 most proximate to the gypsum core. The facer paper cover sheet 16 faces inside of a room after the wallboard panel 10 is installed as an interior wall. A person of skill will appreciate that at least in some embodiments, the backer paper cover sheet 14 may also be multi-ply paper. At least in some other embodiments, at least one paper cover sheet or both paper cover sheets are made of single-ply paper.

In the embodiment of FIG. 1, the bond side 20 of the facer paper cover sheet 16 is coated with an adhesive selected from a group consisting of polyacrylate, polyvinyl acetate, polyvinyl acetate in combination with borax, polyurethane, and any combination thereof. This coating creates an adhesive layer 22. The gypsum core 12 is in contact with and is bonded to the bond side 20 of the facer paper cover sheet 16 with the adhesive layer 22 which comprises polyacrylate, polyvinyl acetate, polyvinyl acetate in combination with borax, polyurethane, or any combination thereof. It will be appreciated that in other embodiments (not shown in FIG. 1), the adhesive layer 22 can be applied to both, the bond side 20 of the facer paper cover sheet 16 and the bond side 24 of the backer paper cover sheet 14.

It will be also appreciated that in other embodiments (not shown in FIG. 1), the adhesive layer 22 can be applied only to the bond side 24 of the backer paper cover sheet 14, while there is no adhesive layer 22 applied to the bond side 20 of the facer paper cover sheet 16. Some embodiments may include the application of the adhesive to the face side of a paper cover sheet. However, the application of the adhesive to the face side of a paper cover sheet is not recommended because this may produce a surface which is tacky and it would be difficult to stack up panels for storage and transportation as such panels may stick together. The application of the adhesive to the face surface of a facer paper cover sheet may also cause problems with application of paints and other decorative finishes to the face surface of a facer cover sheet and therefore the application of the adhesive to the face surface of a facer cover sheet is not recommended for this reason as well.

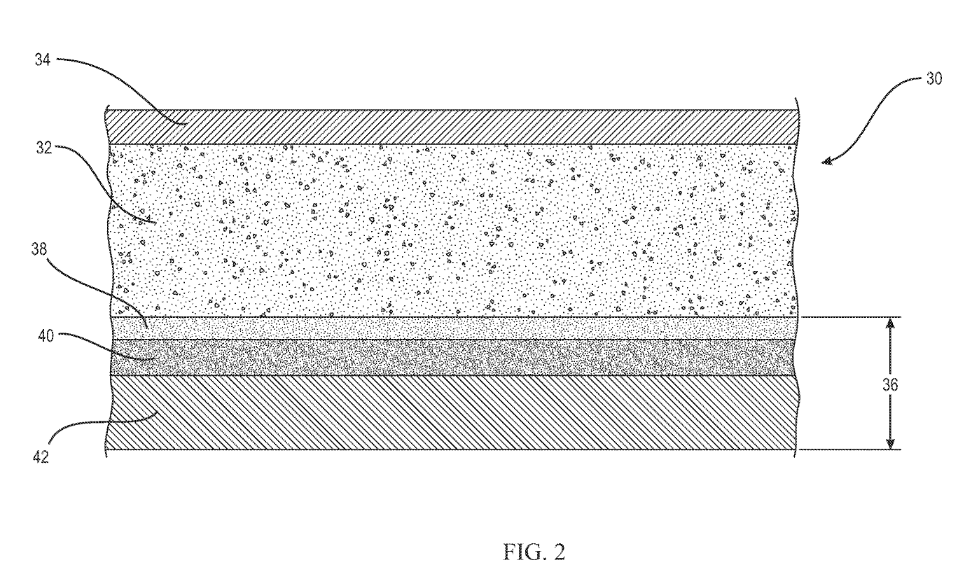

FIG. 2 depicts a further embodiment of a wallboard panel with a laminated paper cover sheet, generally 30. In this embodiment, a gypsum core 32 is sandwiched between a backer paper cover sheet 34 and a facer paper cover sheet 36 which comprises an inner paper sheet 38, adhesive layer 40 and outer paper sheet 42. The inner paper sheet 38 is in contact with and covers the gypsum core 32. An adhesive layer 40 covers the inner paper sheet 38 on the surface distal to the gypsum core, and an outer paper sheet 42 covers the adhesive layer 40. Thus, the adhesive layer 40 is sandwiched between the inner paper sheet 38 and the outer paper sheet 42. The adhesive layer 40 binds together the inner paper sheet 38 and outer paper sheet 42. Thus, the laminated facer paper cover sheet 36 comprises the inner paper sheet 38, the adhesive layer 40 and the outer paper sheet 42. The adhesive layer 40 comprises a binder selected from polyacrylate, polyvinyl acetate, polyvinyl acetate in combination with borax, polyurethane, or any combination thereof. While in the embodiment of FIG. 2, the facer paper cover sheet is laminated, in other embodiments the backer paper cover sheet can be also a laminated paper cover sheet comprising the inner paper sheet, adhesive layer and outer paper sheet.

It will be further appreciated that while in the embodiment of FIG. 2, the adhesive layer 40 is applied between the inner paper sheet 36 and the outer paper sheet 38, in some other embodiments, another adhesive layer 40 can be applied between the gypsum core 32 and the inner paper sheet 38 in addition to or instead of the adhesive layer 40 being applied between the inner paper sheet 38 and the outer paper sheet 42. In further embodiments, a wallboard is prepared such that the gypsum core 32 is sandwiched between two paper cover sheets where each of the two paper cover sheets is a laminated paper cover sheet comprising an inner paper sheet and outer paper cover sheet adhered together with an adhesive. Further embodiments may include those in which only the backer cover sheet is a laminated paper cover sheet, while the facer cover sheet is multi-ply paper typically used in the wallboard production.

Various paper grades can be used as a paper cover sheet in embodiments of this invention, including multi-ply paper which comprises at least one liner ply and at least one filler ply. Newslined paper, including mold-resistant newslined paper, can be used as a paper cover sheet, and in particular as a backer paper cover sheet, in some embodiments. Manila paper with a smooth calendered finish can be used as a facer paper cover sheet in some embodiments. Kraft paper can be used as a facer paper cover sheet in other embodiments. At least is some embodiments, paper used as a facer is a multi-ply paper. Suitable paper includes paper with the bond side Cobb values as low as 0.6 g/100 cm². In some embodiments, a paper cover sheet comprises multi-ply paper in which paper ply on the bond side is water absorbent. The term “water absorbent” as used in this specification is to be understood as averaging from about 30 g/m² to about 200 g/m² in the Cobb test (TAPPI T 441 om-04, entitled “Water absorptiveness of sized (non-bibulous) paper, paperboard and corrugated fiberboard (Cobb test)”) in which a gypsum product is submerged under a 1 cm head of water at 23° C. for 2 minutes and the amount of water absorbed by the gypsum product is then calculated. Some embodiments include those in which a paper cover sheet is prepared from water absorbent paper with the water absorption from 30 g/m² to 200 g/m² as measured in the Cobb test (TAPPI T 441 om-04).

Using the adhesive layer applied over the bond side of a paper cover sheet provides a technical advantage of increasing mold-resistance and moisture-resistance for a wallboard panel. Using the adhesive layer applied over the bond side of a paper cover sheet also provides a technical advantage of increasing the nail-pull strength of a wallboard panel.

At least in some embodiments, paper is made with recycled materials, including recycled newspaper. At least in some embodiments, suitable paper is made of 90% to 70% of recycled newspaper and 10% to 30% fly leaf fibers which are short fibers ranging in length between 0.8 to 1.5 mm and with the ash content typically between 20-25%.

During sizing of Manila grade paper, typically, 8 to 10 lb/ton of alkenylsuccinic anhydride (ASA) size is applied to the top two liner plies, but the ASA size may be fed as low as 4-5 lb/ton. The filler plies contain ASA size between 3 to 7 lb/ton. Alum is fed to the liner and filler plies at 3 to 7 lb/ton, but typically at 5 lb/ton. The liner furnish is “news sections” which is TMP or groundwood which is a high yield furnish, but low in ash content. The sheet must be dried appropriately so that the ASA size forms covalent bonds to the cellulose. Standard paper making chemicals (retention aids, coagulants) and procedures are followed to obtain a well formed sheet. The average Manila basis weight is 44 lb/MSF and typically a roll weighs 5530 lb and contains 125 MSF/roll.

During sizing of Newslined grade paper, typically 8 to 10 lb/ton of ASA size is applied to the top two liner plies, but the ASA size may be fed as low as 4-5 lb/ton. The filler plies will contain ASA size between 3 to 7 lb/ton. Alum is fed to the liner and filler plies at 3 to 7 lb/ton, but typically at 5 lb/ton. The furnish is “old corrugated” or “double lined Kraft” waste paper. The same wastepaper grades used as filler plies for the Manila grade. The size concentration may be lowered to obtain the bond side Cobb specification. The sheet must be dried appropriately so that the ASA size forms covalent bonds to the cellulose. Standard paper making chemicals (retention aids, coagulants) and procedures are followed to obtain a well formed sheet. The average basis weight is 42b/MSF and typically a roll weighs 5585 lb and contains 133.5 MSF/roll.

Using the present adhesive comprising polyacrylate, polyvinyl acetate, polyvinyl acetate in combination with borax, polyurethane, or any combination thereof for adhering the bond side of a paper cover sheet such as Manila and/or

Newslined paper cover sheet to the gypsum core in a wallboard panel allows decreasing the amount of the sizing agent to be used, which in turn provides a technical advantage of producing a gypsum panel which weighs less, yet meets the compressive strength and nail-pull strength requirements. The present adhesive is also suitable with other grades of paper, including a multi-ply paper and a single-ply paper. Using the present adhesive comprising polyacrylate, polyvinyl acetate, polyvinyl acetate in combination with borax, polyurethane, or any combination thereof also allows to use paper that weighs less and comprises fewer plies for making a gypsum product which weighs less, but still meets the nail-pull test requirements. These requirements are defined in ASTMC 1396/1396M which provides a requirement of no less than 77 lbs for a ½ inch board in the nail-pull resistance test.

The nail-pull resistance test which is defined in ASTM C473 “Standard Test Methods for Physical Testing of Gypsum Panel Products,” measures the force required to pull a gypsum panel off of a wall by forcing a fastening nail through the panel. The reported value for nail-pull resistance is the maximum stress achieved while the nail head penetrates through the board surface and core.

Further technical advantages can be achieved with a laminated paper cover sheet in which the inner paper sheet overlays the gypsum core. In these embodiments, the inner paper sheet can be made from paper which is water absorbent. Suitable paper includes a high Cobb paper. Suitable paper also includes paper with the bond side Cobb values as low as 0.6 g/cm². Suitable paper also includes paper with the bond side Cobb values in the range from 30 g/M² to 200 g/M². Such paper includes paper made from recycled materials, including recycled newspaper. Because of the use of the inner paper sheet and an adhesive, the outer paper sheet in the laminated paper cover sheet can be made from a lighter paper too. The use of a laminated paper cover sheet permits production of lighter wallboard panels which meet the industry requirements for compressive and nail-pull strength.

Some embodiments provide wallboard panels in which the gypsum core is bonded to the bond side of a paper cover sheet with an adhesive layer. Other embodiments employ a laminated paper cover sheet in which an adhesive layer is sandwiched between the inner paper sheet and the outer paper sheet, and the inner paper sheet is in contact with a gypsum core.

The adhesive layer can be generated by cross-linking, curing and polymerizing an adhesive resin which comprises compounds with reactive groups. In some embodiments, the adhesive layer comprises a polyacrylate, polyvinyl acetate, polyvinyl acetate in combination with borax, polyurethane, or any combination thereof.

In some embodiments, the adhesive layer comprises a polyacrylate. This adhesive layer is prepared by causing cross-linking of an acrylic emulsion. Suitable acrylates include, but are not limited to, compounds comprising the acrylic group (CH₂=CHCOO⁻). Such compounds include, but are not limited to, styrene acrylate, vinyl acrylate, styrene acetate acrylate, and any combination thereof. Suitable water-resistant acrylic emulsion can be obtained under the trade name QUIKRETE™ acrylic resin from Quikrete, Inc., Chicago, Ill. In further embodiments, the adhesive layer comprises a combination of polyacrylate and borax.

In some embodiments, the adhesive layer comprises a polyvinyl acetate (PVA). In some preferred embodiments, the adhesive layer comprises ethylene polyvinyl acetate. Suitable ethylene polyvinyl acetate resin can be obtained under the trade name QUIKRETE™ concrete bonding adhesive from Quikrete, Inc., Chicago, Ill. The adhesive layer can also be prepared from a polyvinyl acetate resin available under the trade name ELMER's glue from Elmer's Products, Inc., Westerville, Ohio. In some embodiments, the adhesive layer comprises PVA and borax. Without wishing to be bound by the theory, it is believed that borax acts as an activator for curing PVA.

In some embodiments, a PVA resin can be coated as a layer on the paper cover sheet surface. The surface coated with the PVA resin is then spray-coated with a borax solution. The paper cover sheet surface coated with PVA and borax is then brought in contact with a gypsum slurry and is allowed to cure. This adheres the paper cover sheet to the gypsum core.

In other embodiments, a gypsum slurry can be formulated with borax and brought in contact with a paper cover sheet coated with a PVA resin. In further embodiments, a paper cover sheet can be pre-coated with a borax solution on the surface that will be used as the bond side of a paper cover sheet. For example, paper can be spray-coated with a 10% borax solution during a paper making process. Other suitable concentrations for the borax solution to be used in pre-coating paper include from about 0.1% to about 20% of Sodium Borate in water by weight.

In alternative, borax can be added into a sizing solution typically used for sizing paper during a paper making process. Borax can be added in various amounts to the sizing solution, including to the final concentration from 0.01% to 5% by weight. Various sizing solutions can be used in combination with borax including those comprising starch, ASA size and/or acrylic polymers.

In some embodiments, the adhesive layer comprises polyurethane. A suitable polyurethane adhesive layer can be obtained by crosslinking a polyurethane resin available under the trade name GORILLA™ glue from Gorilla Glue, Inc. Cincinnati, Ohio.

Further embodiments include those in which borax (Sodium Borate) is added to the adhesive layer. In some embodiments, the bond side of a paper cover sheet is coated with a borax solution first. An acrylic, PVA or polyurethane resin is then applied over the borax solution. As discussed above, paper can be pre-coated with borax and stored until used for making a gypsum product. In other embodiments, borax is mixed with the PVA resin and is then applied to the bond side of a paper cover sheet. Yet in further embodiments, a gypsum slurry is formulated with borax and then placed in contact with a paper cover sheet coated with PVA or polyurethane, and the resulting product is allowed to dry and PVA is allowed to cure.

Various concentrations of a PVA resin are suitable, including without any limitation, a resin comprising from about 0.1% PVA to about 20% PVA in water. At least in some embodiments, a PVA resin is used in the concentration from about 1% to about 10%. At least in some embodiments, a PVA resin is used in the concentration from about 1% to about 15%.

Various borax solutions are suitable. At least in some embodiments, a borax solution to be applied to the cover paper sheet surface comprises from about 1% to about 50% of Sodium Borate. In other embodiments, a suitable solution comprises from about 1% to about 10% of Sodium Borate. Yet in further embodiments, the solution comprises from about 0.1% to about 5% of Sodium Borate.

In some embodiments, borax can be added as a powder to a gypsum slurry or to a PVA resin. The total amount of borax to be added may vary and can be in the range from 0.1% to about 5% by weight of the total weight of dry ingredients in the gypsum slurry or by weight of the total weight of a PVA resin. In some embodiments, borax can be added as a powder to a sizing solution during a paper making process. The total amount of borax to be added may vary and can be in the range from 0.1% to about 5% by weight of the total weight of dry ingredients in the gypsum slurry or by weight of the total weight of a PVA resin.

Various methods can be used for manufacturing a wallboard panel in which the gypsum core is bonded to the bond side of a paper cover sheet with an adhesive layer. In some embodiments, the bond side of a facer paper cover sheet, of a backer paper cover sheet or each of the two paper cover sheets is coated with a coating comprising, consisting essentially of or consisting of an acrylic, PVA, PVA and borax, and/or polyurethane resin. In some embodiments, this coating is applied to the bond side of a paper cover sheet by using a spray bar, direct roll coater or curtain coater. A gypsum slurry is then distributed over the bond side of the facer paper sheet while the coating is still wet and has not fully polymerized yet. A second paper sheet, the backer paper sheet, is rolled over the gypsum slurry, and the resulting wallboard is allowed to dry.

In further embodiments of the method, the bond side of the backer paper cover sheet is also coated with a coating comprising, consisting essentially of or consisting of an acrylic, PVA, PVA and borax, and/or polyurethane resin, and the coated backer paper cover sheet is rolled over the gypsum slurry while the polymeric coating is still wet and has not fully polymerized yet.

Further embodiments include methods in which the bond side of only the facer paper cover sheet, the bond side of only the backer paper cover sheet or the bond side of the facer paper cover sheet and of the backer paper cover sheet are coated with a coating comprising, consisting essentially of or consisting of an acrylic, PVA, PVA and borax, and/or polyurethane resin. At least in some embodiments, the coating further comprises borax which can either be mixed with an acrylic, PVA, and/or polyurethane resin or applied over as a solution in a separate layer over or under a coating comprising, consisting essentially of or consisting of an acrylic, PVA and/or polyurethane resin.

The coated bond side of these paper cover sheets is placed in contact with a gypsum slurry while the polymeric coating is still wet and the coating is allowed to polymerize and cure after it has been brought in contact with the gypsum slurry which is setting. Thus, the bond side of the paper cover sheet is bonded to the forming gypsum core via an adhesive layer (polymeric coating) as polymerization takes place in the adhesive layer.

This method can be used in combination with a great variety of gypsum slurries. Typically, a gypsum slurry comprises calcined gypsum (calcium sulfate hemihydrate), water and at least one of a binder, filler, set retarder, set accelerator, foam, defoamer, surfactants, biocide, dispersant, humectant, and fibers. In a gypsum slurry, calcium sulfate hemihydrate comes in contact with water which results in hydration and formation of gypsum (calcium sulfate dihydrate) crystals. A particularly preferred gypsum slurry is a gypsum slurry comprising borax.

In the present method, the gypsum slurry is deposited over the bond side coated with an adhesive resin which is still wet and is in process of cross-linking and polymerization. The two processes, formation of gypsum crystals and cross-linking and hardening of the polymeric resin take place simultaneously. This results in formation of a matrix in which gypsum crystals are incorporated into the cross-linked adhesive layer and leads to a very robust bonding of the gypsum core to the paper cover sheet.

In further embodiments, a laminated wallboard panel is produced by coating the bond side a paper cover sheet with a polymerizable resin and adhering a water-absorbent paper over the coating while the coating is still wet and has not fully polymerized yet. As the coating dries and polymerizable resin polymerizes and cures, a laminated paper cover sheet is produced in which water-absorbent paper is now bonded to the paper cover sheet. A gypsum slurry is then distributed over the water-absorbent paper which is bonded to the paper cover sheet via an adhesive layer. In some preferred embodiments, a high Cobb or water-absorbent paper is used for making this laminated paper cover sheet. In other embodiments, a paper with the bond side Cobb values as low as 0.6 g/100 cm² may be used. Suitable water-absorbent paper also includes paper with the Cobb value from 30 g/m² to 200 g/m² as measured by the Cobb test (TAPPI T 441 om-04, entitled “Water absorptiveness of sized (non-bibulous). The paper may be treated with various chemicals, including, but not limited to, Borax.

A second paper cover sheet which in some embodiments is also a laminated paper cover sheet is then rolled over the gypsum slurry and the laminated wallboard panel is allowed to dry.

Various standard tests are used for determining the strength of a gypsum panel. Such tests are described in ASTM C473 “Standard test methods for physical testing of gypsum panel products.” One of such test is the ASTM nail-pull resistance test which measures the force required to pull a gypsum panel off a wall by forcing a fastening nail through the gypsum panel. The reported value for nail-pull resistance is the maximum stress achieved while the nail head penetrates through the wallboard paper cover sheet and gypsum core. ASTM C1396 “Standard Specification for Gypsum Board” defines the minimum specification limit to be 77 lbs for a ½″ gypsum board.

One of technical advantages for a wallboard panel of this invention, prepared with a paper cover sheet bonded to the gypsum core with the adhesive comprising, consisting essentially of or consisting of an acrylic resin, PVA resin, PVA resin in combination with borax, polyurethane resin or any mixture thereof is that this wallboard panel performs well in the nail-pull resistance test. Such wallboard can be made lighter than a conventional wallboard, but this inventive wallboard still meets the standard of 77 lbs for a ½ inch board in the nail-pull resistance test.

The invention will now be explained in more detail by the way of the following non-limiting examples.

### Example 1

### Comparative Analysis

Several different adhesive formulations were prepared, including 2% acrylic resin, 1% polyvinyl acetate (PVA) resin and ELMER's PVA glue diluted to 5%.

Each of the resins was coated on the bond side of a paper cover sheet. The coated sheets were immediately used for preparing wallboard samples and the coated sheets became bonded to the gypsum core.

A nail-pull strength test was conducted on these samples in comparison with a control wallboard sample in which a paper cover sheet was bonded to the gypsum core without an adhesive layer and simply by allowing the gypsum slurry to set after it has been covered with a paper cover sheet. The results of these tests are shown below.

TABLE 1
Nail Pull Test for Wallboards

| | | | | 1% Ethylene |
|---|---|---|---|---|
| | | | | polyvinyl |
| | Control (No | 2% Acrylic | 5% PVA | acetate |
| | Adhesive | Adhesive | Adhesive | Adhesive |
| | Layer) | Layer | Layer | Layer |
| Test 1 | 84.74 | 89.34 | 83.02 | 85.62 |
| Test 2 | 82.72 | 86.16 | 95.44 | 89.41 |
| Test 3 | 82.86 | 91.36 | 90.67 | 77.17 |
| Test 4 | 78.76 | 82.97 | 83.98 | 80.16 |
| Ave. | 82.27 | 87.45 | 88.27 | 83.09 |

As can be seen from these comparative tests, the strength of wallboard can be increased without increasing the paper weight if a paper cover sheet is bonded to a gypsum core with the adhesive layer comprising, consisting essentially of or consisting of polyacrylate, PVA or PVA in combination with borax. This may provide a technical advantage of lowering wallboard weight, while still maintaining the required standard value in the nail-pull test. Other advantages include the possibility of using lighter paper and/or using paper which is unsized or sized only lightly as a paper cover sheet.

What is claimed is:

1. A wallboard panel comprising a gypsum core sandwiched between two paper cover sheets, a facer paper cover sheet and a backer cover sheet, each paper cover sheet in contact with and covering the gypsum core,
wherein each paper cover sheet has a surface proximate to the gypsum core, the bond side of the paper cover sheet, and
wherein the bond side of at least one paper cover sheet is coated with an adhesive selected from the group consisting of polyacrylate, polyvinyl acetate, polyvinyl acetate and borax, polyurethane, and any combination thereof.

2. The wallboard panel of claim 1, wherein the bond side of each of the two paper cover sheets is coated with the adhesive.

3. The wallboard panel of claim 1, wherein at least one paper cover sheet is multi-ply paper which comprises at least one liner ply and at least one filler ply.

4. The wallboard panel of claim 1, wherein the facer paper cover sheet is multi-ply paper in which at least one inner ply is sized.

5. The wallboard panel of claim 1, wherein at least one of the facer paper cover sheet and the backer cover sheet comprises multi-ply paper which is water absorbent with the water absorption value in the range from 30 g/M² to 200 g/M² as measured by the Cobb test (TAPPI T 441).

6. The wallboard panel of claim 1, wherein the adhesive is a polyacrylate selected from the group consisting of styrene acrylate, vinyl acrylate, styrene acetate acrylate, and any combination thereof.

7. The wallboard panel of claim 1, wherein the adhesive comprises polyvinyl acetate and borax.

8. A wallboard panel comprising a gypsum core and at least one laminated paper cover sheet in contact with and covering the gypsum core,
wherein the laminated paper cover sheet comprises an inner paper sheet, an adhesive layer, and outer paper sheet, the inner paper sheet being in contact with the gypsum core on one surface and the inner paper sheet being in contact with the adhesive layer on the other surface,
wherein the outer paper sheet is applied over the adhesive layer, and wherein the second adhesive layer is sandwiched between the inner paper sheet and outer paper sheet, and
wherein the adhesive layer binds the inner paper sheet and outer paper sheet together.

9. The wallboard panel of claim 8, wherein the adhesive layer comprises a binder selected from the group consisting of polyacrylate, polyvinyl acetate, polyvinyl acetate and borax, polyurethane, and any combination thereof.

10. The wallboard panel of claim 8, comprising a second adhesive layer positioned between the gypsum core and the inner paper sheet.

11. The wallboard panel of claim 10, wherein the second adhesive layer comprises a compound selected from the group consisting of polyacrylate, polyvinyl acetate, polyvinyl acetate and borax, polyurethane, and any combination thereof.

12. The wallboard panel of claim 8, wherein the gypsum core is covered with the laminated paper cover sheet on both sides.

13. The wallboard panel of claim 8, wherein the outer paper sheet in the laminated paper cover sheet is multi-ply paper.

14. The wallboard panel of claim 8, wherein the inner paper sheet is water absorbent with the water absorption value in the range from 30 g/M² to 200 g/M² as measured by the Cobb test (TAPPI T 441).

15. The wallboard panel of claim 8, wherein the inner paper sheet has the bond side Cobb value of at least 0.6 g/cm².

16. A method of making a wallboard panel, the method comprising:
Applying a coating to the bond side of a first paper cover sheet, wherein the coating comprises a compound selected from the group consisting of an acrylic resin, PVA resin, PVA resin and borax, polyurethane resin and any mixture thereof;
Depositing a gypsum slurry over the coated bond side of the paper cover sheet while the coating has not fully cured;
Covering the gypsum slurry with a second paper cover sheet; and
Allowing the gypsum slurry to set and the coating to cure.

17. The method of claim 16, further comprises a step of applying to the bond side of the second paper cover sheet a coating comprising an acrylic resin, PVA resin, PVA resin and borax, polyurethane resin or any mixture thereof, and
wherein the step of covering the gypsum slurry with the second paper cover sheet is performed before the coating on the bond side of the second paper cover sheet has fully cured.

18. The method of claim 16, wherein borax is applied to the bond side of at least one of the first paper cover and the second paper cover sheet prior to the application of the coating, after the application of the coating or borax is mixed with the gypsum slurry.

19. A method of making a laminated wallboard panel, the method comprising:
Binding water-absorbent paper with the water absorption value in the range from 30 g/M2 to 200 g/M2 as measured by the Cobb test (TAPPI T 441) with an adhesive selected from the group consisting of an acrylic resin, PVA resin, PVA resin and borax, polyurethane resin and any mixture thereof to a paper cover sheet and thereby creating a laminated paper cover sheet;
Depositing a gypsum slurry over the water absorbent paper of the laminated paper cover sheet; and
Applying a second paper cover sheet over the gypsum slurry.

20. The method of claim 19, wherein the second paper cover sheet is also a laminated paper cover sheet comprising water-absorbent paper with the water absorption value in the range from 30 g/M² to 200 g/M² as measured by the Cobb test (TAPPI T 441) to a paper cover sheet with an adhesive selected form the group consisting of an acrylic resin, PVA resin, PVA and borax, polyurethane resin or any mixture thereof.
